(19) United States
(12) Patent Application Publication
(10) Pub. No.: US 2026/0234411 A1
(43) Pub. Date: Aug. 13, 2026

(54) METHOD FOR COATING A SUBSTRATE

(71) Applicant: LAMBERTI SPA, Albizzate (IT)

(72) Inventors: Silvia MANSI, Varese (IT); Daria DIAMANTE, Varese (IT); Livia BIGANZOLI, Sesto Calende (IT); Mariuccia DE LUCA, Lonate Pozzolo (IT)

(73) Assignee: LAMBERTI SPA, Albizzate, VA (IT)

(21) Appl. No.: 19/469,305

(22) PCT Filed: Dec. 18, 2023
(86) PCT No.: PCT/EP2023/086249

§ 371 Date: Sep. 25, 2025

(30) Foreign Application Priority Data
Apr. 7, 2023 (IT) 102023000006927

(51) Int. Cl. C09D 4/06; C09D 175/14

(52) U.S. Cl. CPC C09D 4/06; C09D 175/14

(57) ABSTRACT

The present invention relates to a method for coating a substrate comprising: i) applying an aqueous radiation-curable coating composition to said substrate; ii) thermally drying the applied aqueous radiation-curable coating composition; iii) irradiating the thermally dried composition with UV light having a wavelength≤300 nm under inert gas; iv) irradiating the thermally dried composition with UV light having a wavelength≥250 nm or with E-beam, wherein the aqueous radiation-curable coating composition comprises: A) from 15 to 60 wt % (% by weight) of a polyurethane; B) from 1 to 35 wt % of at least one unsaturated reactive diluent.

### TECHNICAL FIELD

The present invention relates to a method for coating a substrate in order to provide it with a low gloss coating using an aqueous radiation-curable coating composition.

### STATE OF THE ART

Gloss is associated with the capacity of a surface to reflect more light in some directions than in others. High gloss surfaces reflect a high proportion of light directed at them, while low gloss surfaces reflect a low proportion of light directed at them. Low gloss coatings that produce less image impairment are often more pleasing aesthetically.

Traditionally, low gloss coating compositions are obtained by the addition of matting agents such as silica particles. However, when said traditional matting agents are added to aqueous radiation-curable coating compositions, the addition of heterogeneous particles has the disadvantage of destabilizing aqueous radiation-curable coating compositions and of increasing the brittleness of the film. Moreover, during the application, a separation of the heterogeneous materials can occur with consequent heterogeneity of the optical effect along the surface of the treated material. In addition, traditional matting agents tend to adversely affect the chemical resistances, and particularly solvent and stain resistances, of a surface treated with an aqueous radiation-curable coating composition.

A known alternative to the use of traditional matting agents is excimer lamp technology, i.e the pretreatment of radiation-curable coating formulations with high-energy radiation in the wavelength of ≤300 nm under inert gas to produce low gloss or even matte coatings. The effect achieved by this pre-treatment with short-wave UV light is a photochemically induced micro-folding of the coating, which is responsible for a low gloss or even matte surface. Full curing of the coating composition below the folded surface then takes place with conventional UV emitters such as for example mercury medium-pressure emitters or electron beam emitters.

In this context, US2014371384 describes a method for producing matt surfaces by using the excimer lamp technology with a radiation-curable coating composition having a solids content of 100 wt %, which is a water-free composition. Particularly, the method therein described comprises the following steps: (1) applying a radiation-curable coating agent to a substrate; (2) irradiating the radiation-curable coating from step (1) with UV light having a wavelength from ≥200 nm to ≤420 nm in a radiation dose from 25 to 120 mJ/cm²; (3) irradiating the coating obtained from step (2) with UV light having a wavelength from ≥120 nm to ≤230 nm; (4) finish-curing the coating obtainable from step (3) by actinic radiation. WO2022175492 relates to a method for obtaining a low gloss or even matte coatings by combining the excimer lamp technology with a radiation-curable coating composition having a solids content of 100 wt %, i.e. a water-free composition. The method therein described allow to obtain a low gloss or even matte coatings with just two irradiation steps, thus eliminating the partial gelation irradiation step needed prior to the excimer radiation step. Particularly, WO2022175492 relates to a process for producing a coating, comprising: (1) irradiating a radiation-curable coating composition with UV light having a wavelength λ≤220 nm under inert gas, followed by (2) irradiating with UV light having a wavelength λ≥300 nm or with E-beam (electron beam), wherein the radiation-curable coating composition comprises (A) one or more oligomeric urethane acrylates (A) with molar mass of from 1100 to 5000 g/mol and with an acrylate functionality of from 4 to 14, and (B) one or more acrylate diluents (B) with a molar mass less than 650 g/mol and with an acrylate functionality of from 2 to 4, and wherein the amount of (A) is from 20 to 75 wt % and the amount of (B) is from 25 to 80 wt %, based on the total amount of (A) and (B), and the total amount of (A) and (B) is at least 50 wt. % by weight of the radiation-curable coating composition.

Surprisingly, it has now been found that low gloss or even matte coatings with improved stain resistances can be obtained by combining the excimer lamp technology with an aqueous radiation-curable coating composition.

In addition, aqueous radiation-curable coating compositions are advantageous over the water-free coating compositions commonly used in the prior art, as they are suitable for spray application and generate less odour throughout all the coating process.

### SUMMARY OF THE INVENTION

It is therefore an object of the present invention a method for coating a substrate comprising:
i) applying an aqueous radiation-curable coating composition to said substrate;
ii) thermally drying the applied aqueous radiation-curable coating composition;
iii) irradiating the thermally dried composition with UV light having a wavelength≤300 nm under inert gas;
iv) irradiating the thermally dried composition with UV light having a wavelength≥250 nm or with E-beam,
   wherein the aqueous radiation-curable coating composition comprises:
   A) from 15 to 60 wt % (% by weight) of a polyurethane, wherein said polyurethane is obtained by a process comprising the following steps:
I) a prepolymer is obtained by reacting:
   a) from 20 to 60 wt % of at least one aliphatic or cycloaliphatic diisocyanate;
   b) from 0.5 to 10 wt % of least one diol having at least one carboxylic or carboxylate group;
   c) from 10 to 60 wt % of at least one diol with molecular weight between 500 and 5,000 g/mol;
   d) from 0 to 40 wt % of at least one ethylenically unsaturated compound containing one reactive group capable to react with an isocyanate;
   e) from 0 to 10 wt % of at least one diol or at least one polyol different from diols b) and c);
   f) from 0 to 20 wt % of an aliphatic or cycloaliphatic polyisocyanate having average functionality above 2,
wherein the percentage amounts of a), b), c), d), e) and f) are referred to the sum of a)+b)+c)+d)+e)+f);
II) the prepolymer obtained in step I) is reacted with a capping agent, said capping agent being a secondary amine or a monoalcohol, in such proportions that the molar ratio between the amino groups or hydroxy groups of the capping agent and the isocyanate groups (NCO) of the prepolymer is between 0.3 and 1;
III) the capped prepolymer obtained in step II) is dispersed in water;
   B) from 1 to 35 wt % of at least one unsaturated reactive diluent.

### DETAILED DESCRIPTION OF THE INVENTION

The aqueous radiation-curable coating composition of the invention comprises from 15 to 60 wt %, preferably from 20 to 40 wt % of a polyurethane.

The process for preparing the polyurethane of the present invention comprises the following steps:
I) reaction of components a) to c) and optionally d), e) or f) to form a polyurethane prepolymer,
II) reaction of the prepolymer obtained in step I) with a capping agent,
III) dispersion in water of the capped prepolymer obtained in step II), optionally in the presence of a chain extender,
IV) addition of at least one unsaturated reactive diluent during steps I), II) or III), or after step III).

Component a) is at least one aliphatic or cycloaliphatic diisocyanate. The amount of component a) relative to the total amount of components used to prepare the prepolymer is from 20 to 60 wt %, preferably from 30 to 50 wt %.

Examples of diisocyanates useful for the preparation of the polyurethane of the present invention are 1-isocyanate-3-isocyanate-methyl-3,5,5-trimethylcyclohexane (or isophorone diisocyanate), 4,4′-dicyclohexyl-methane-diisocyanate, hexamethylene diisocyanate, and mixtures thereof; most preferably the diisocyanate is isophorone diisocyanate. Mixtures of aliphatic and cycloaliphatic diisocyanates may be used.

Component b) is at least one diol having at least one carboxylic or carboxylate group, typically having molecular weight of from 100 to 500 g/mol. The amount of component b) relative to the total amount of components used to prepare the prepolymer is from 0.5 to 10 wt %, preferably from 2 to 8 wt %.

Preferably component b) is a carboxylic acid or salt thereof which is substituted in the position 2 by two hydroxymethyl groups; more preferably component b) is dimethylolpropionic acid (DMPA), dimethylolbutanoic acid (DMBA) or mixtures thereof; most preferably component b) is dimethylolpropionic acid.

The carboxylic groups of component b) are preferably fully or partially in the form of a salt. Conversion to the salt form is conducted by neutralisation with a base, preferably after the preparation of the prepolymer and before its dispersion in water. The base is preferably ammonia, an amine or an inorganic base. Suitable amines include tertiary amines, for example triethylamine or N,N-dimethylethanolamine, acryloyl morpholine (ACMO) or methyl morpholine. Suitable inorganic bases include alkali hydroxides and carbonates, for example lithium hydroxide, sodium hydroxide, or potassium hydroxide.

Component c) is at least one diol with molecular weight between 500 and 5,000 g/mol. The amount of component c) relative to the total amount of components used to prepare the prepolymer is from 10 to 60 wt %, preferably from 20 to 50 wt %.

As component c), nonionic polyether diols, polyester diols and polycarbonate diols, or mixtures thereof, may be used.

Among the utilizable polyester diols are those obtained, for example, by reacting dicarboxylic acids, or possibly the corresponding anhydrides or methyl esters, with diols, optionally in the presence of known esterification catalysts.

Examples of suitable acids or anhydrides include adipic acid, succinic acid, maleic acid, sebacic acid, azelaic acids, the various commercially available dimeric fatty acids in saturated (hydrogenated) or unsaturated form, itaconic acid, phthalic acid, isophthalic acid, tetrahydrophthalic acid, 1,4-cyclohexanedicarboxylic acid and hexahydrophthalic acid; adipic acid, succinic acid, maleic acid, sebacic acid and azelaic acids are preferred.

Suitable diols for the preparation of the polyester diols are, for example, ethylene glycol, 1,2- and 1,3-propanediol, 1,3- and 1,4-butanediol, 1,6-hexanediol, 3-methyl-1,5-pentanediol, 1,5-pentanediol, cyclohexanedimethanol, diethylene glycol, dipropylene glycol, neopentyl glycol and mixtures thereof, such as mixtures of 1,6-hexanediol and 1,5-pentanediol or of 1,6-hexanediol and neopentyl glycol. Other useful polyester diols are those obtainable from diol-initiated polymerization of hydroxy carboxylic acids containing from 2 to 26, and preferably from 4 to 12 carbon atoms, or a lactone thereof. The hydroxy carboxylic acids may be saturated or unsaturated, linear or branched.

Examples of suitable hydroxy carboxylic acids are glycolic acid, lactic acid, 5-hydroxy valeric acid, 6-hydroxy caproic acid, ricinoleic acid, 12-hydroxy stearic acid, 12-hydroxydodecanoic acid, 5-hydroxydodecanoic acid, 5-hydroxydecanoic acid and 4-hydroxydecanoic acid. Examples of suitable lactones are β-propiolactone and, optionally C₁-C₆-alkyl substituted, δ-valerolactone and ε-caprolactone, such as β-methyl-δ-valerolactone. Polyester diols obtained from ε-caprolactone are especially preferred.

Useful polyether diols include products obtained by the polymerization of cyclic oxides, for example ethylene oxide, propylene oxide, butylene oxide, tetrahydrofuran, ethoxylated polyether-1,3-diols, and mixture thereof.

Especially useful polyether diols include polyoxypropylene diol, poly(oxyethylene-oxypropylene) diol and poly(tetramethylene glycol)diol.

The preferred polyether diol is poly(tetramethylene glycol)diol.

The polycarbonate diols are those obtained, for example, by reacting carbonic acid derivatives, such as diphenyl carbonate or phosgene, and diols. Suitable diols include those mentioned above for the preparation of the polyester diols. The preferred polycarbonate diol is 1,6-hexanediol polycarbonate.

Mixtures of different diols may be used as components c). Polyether diols and polycarbonate diols, are preferred.

The molecular weight of the polymeric diols c) is calculated from the hydroxyl number.

Component d) is at least one ethylenically unsaturated compound containing one reactive group capable to react with an isocyanate. The amount of component d) relative to the total amount of components used to prepare the prepolymer is from 0 to 40 wt %, preferably from 5 to 30 wt %.

Component d) contains from one to five, preferably one to three radiation curable carbon-carbon double bonds, preferably (meth)acrylic groups.

Among the groups present in d) that are able to react with isocyanate groups are hydroxyl groups, primary and secondary amino groups and thio groups. Hydroxyl groups are preferred. Most preferably, component d) is made of compounds containing one group that is able to react with isocyanate groups, especially one hydroxyl group, and one, two or three (meth)acrylic groups.

More generally, component (d) may be made of partial esters of (meth)acrylic acid with di- or polyols preferably having 2 to 20 carbon atoms, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, neopentylglycol, 1,5-pentanediol, 1,6-hexanediol, trimethylolpropane, trimethylolbutane, pentaerythritol, dipentaerythritol, ditrimethylolpropane, erythritol, sorbitol.

In addition, it is also possible to use esters or amides of (meth)acrylic acid with amino alcohols, examples being 2-aminoethanol, 2-(methylamino) ethanol, 3-amino-1-propanol, 1-amino-2-propanol or 2-(2-aminoethoxy) ethanol. Preference is given to using 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, trimethylolpropane di(meth)acrylate, pentaerythrityl tri(meth)acrylate.

2-hydroxyethyl (meth)acrylate and pentaerythrityl tri(meth)acrylate are particularly preferred.

Component d) may be made of technical grade mixtures from the (meth)acrylation of trimethylolpropane, pentaerythritol, ditrimethylolpropane or dipentaerythritol. These are usually mixtures of completely and incompletely (meth)acrylated polyols, preferably with an average of about one non-esterified hydroxy group. Technical grade mixtures of pentaerythrityl triacrylate that comprise minor amounts of pentaerythrityl tetraacrylate and pentaerythrityl diacrylate, and have averagely about one hydroxy group per molecule are also particularly preferred.

Component e) is at least one diol or at least one polyol different from the diols b) and c). The amount of component e) relative to the total amount of components used to prepare the prepolymer is from 0 to 10 wt %, preferably from 0 to 5 wt %.

For the component e), suitable diols are propylene glycol, 1,4-butanediol, 1,6-hexanediol, neopentylglycol, cyclohexane dimethanol or mixtures thereof. Suitable polyols include glycerin, pentaerythritol, trimethylolpropane and its derivatives, such as a functional polypropylene glycol started on trimethylolpropane.

Component f) is at least one aliphatic or cycloaliphatic polyisocyanate having average functionality above 2.

The amount of component f) relative to the total amount of components used to prepare the prepolymer is from 0 to 20 wt %, preferably from 0 to 10 wt %.

Component f) has average functionality above 2, preferably from 2.3 and 4. Examples of suitable polyisocyanates are hexamethylene diisocyanate isocyanurate, hexamethylene diisocyanate biuret, isophoronediisocyanate isocyanurate and isophoronediisocyanate biuret.

The reaction of step I) may take place in the presence of a solvent or with the neat reactants at temperatures from 15 to 200° C., preferably at temperatures from 50 to 100° C.

The solvent, if present in step I), shall be chosen among solvents that are not reactive toward the isocyanate groups.

Examples of solvents that can be used in step I) are solvents having low boiling point such as methyl ethyl ketone (MEK), ethyl acetate and acetone, or high boiling solvents such as N-methylpyrrolidone, dipropylene glycol dimethyl ether, propyleneglycol monomethyl ether acetate, dipropyleneglycol monomethyl ether acetate, propyleneglycol diacetate, diethyleneglycol monobutyl ether acetate. The low boiling solvent, if present, is preferably removed by evaporation after dispersion in water of the prepolymer.

The completion of the reaction of step I) may be monitored by measuring the —NCO content, according to the ASTM D2572-19 method, until the expected-NCO content is reached.

In the reaction of step I) the ratio between the isocyanate (NCO) groups and hydroxyl (OH) groups is typically between 1.05 and 5.0, preferably from 1.3 to 2.0, more preferably from 1.4 to 1.8.

In the step II), the prepolymer obtained in step I) is reacted with a capping agent, said capping agent being a secondary amine or a monoalcohol, in such proportions that molar ratio between the amino groups or hydroxy groups of the capping agent and the isocyanate groups (NCO) of the prepolymer is between 0.3 and 1, preferably between 0.4 and 1, more preferably between 0.5 and 1.

Suitable secondary amines include dialkylamines, dialkyalkanolamines or monoalkylalkanolamines, represented by the formula X—R₁—NH—R₂—X, wherein X═H or OH, R₁ and R₂ are linear or branched, saturated or unsaturated alkyl chains containing from 1 to 20 carbon atoms, preferably from 1 to 10 carbon atoms. Exemplary secondary amines include dimethylamine, diethylamine, dipropylamine, diisopropylamine, dibutylamine, N-propyl butylamine, N-methyl ethanolamine or diethanolamine.

Suitable monoalcohols are represented by the formula R₃—(OCH₂CH₂)ₙ—OH, wherein n is an integer number ranging from 0 to 40, preferably from 0 to 20, R₃ is a linear or branched, saturated or unsaturated alkyl chain containing from 1 to 20 carbon atoms, preferably from 1 to 10 carbon atoms. Exemplary monoalcohols include butyl alcohol, isopropyl alcohol, isoamyl alcohol, or methoxy polyethylene glycol.

Said capping agent is preferably a secondary amine, more preferably dibutylamine.

Optionally, in step III) the residual isocyanate groups, if any, are reacted in water with a chain extender, which is preferably used in about a stoechiometric amount.

Specific examples of chain extenders that can be used are ethylene diamine, diethylene triamine, triethylene tetramine, propylene diamine, butylene diamine, hexamethylene diamine, cyclohexylene diamine, piperazine, 2-methyl piperazine, phenylene diamine, toluylene diamine, xylylene diamine, tri (2-aminoethyl) amine, methane diamine, m-xylene diamine, isophorone diamine. Also suitable are hydrazine (e.g. in the form of its mono-hydrate), azines such as acetone azine, substituted hydrazines such as, for example, dimethyl hydrazine, 1,6-hexamethylene-bis-hydrazine, carbodihydrazine. Also dihydrazides such as adipic acid dihydrazides are suitable chain extenders. Another suitable class of chain extenders is the so-called Jeffamine® compounds with a functionality of 2 or 3 (available from Huntsman). These are polypropylene oxide (PPO) or polyethylene oxide (PEO)-based di- or triamines, e.g. Jeffamine® T403 and Jeffamine® D-400.

Anionic chain extenders, such as the sodium salt of 2-[(2-aminoethyl)amino]ethanesulfonic acid may also be used.

The aqueous radiation-curable coating composition of the invention comprises B) from 1 to 35 wt %, preferably from 2 to 20 wt % of at least one unsaturated reactive diluent.

Said unsaturated reactive diluent is preferably added to the aqueous radiation-curable coating composition when the reaction of step I) takes place. Otherwise, the unsaturated reactive diluent may be added subsequently, i.e. during steps II) or III), or after step III).

The unsaturated reactive diluent is a liquid, low viscous compound that contains radiation curable groups, preferably (meth)acrylic groups, and no groups that react with the isocyanate groups. It preferably has a Brookfield® viscosity below 150 mPa*s at 25° C.

A mixture of different unsaturated reactive diluents may be used.

Examples of mono-unsaturated reactive diluents are, for example, esters of (meth)acrylic acid with alcohols having 1 to 20 carbon atoms, examples being methyl (meth)acrylate, ethyl (meth)acrylate, butyl (meth)acrylate, 2-ethylhexyl (meth)acrylate, lauryl (meth)acrylate, isodecyl (meth)acrylate, isobornyl (meth)acrylate; vinyl esters, e.g. vinyl acetate, vinyl propionate; cyclic monounsaturated compounds, e.g. N-vinylformamide; monoethylenically unsaturated carboxylic acids having 3 to 8 carbon atoms and water-soluble alkali metal, alkaline earth metal or ammonium salts thereof, for example acrylic acid, methacrylic acid, crotonic acid, fumaric acid, itaconic acid, maleic acid; N-vinyl pyrrolidone; vinyl methyl oxazolidinone (VMOX); N-vinyllactams such as N-vinylcaprolactam, N-vinyl-N-alkylcarboxamides or N-vinylcarboxamides, such as N-vinylacetamide, N-vinyl-N-methylformamide, N-vinyl-N-methylacetamide; vinyl ethers, such as methyl vinyl ether, ethyl vinyl ether, n-propyl vinyl ether, isopropyl vinyl ether, n-butyl vinyl ether, sec-butyl vinyl ether, isobutyl vinyl ether, ter-butyl vinyl ether; or mixtures thereof.

Examples of unsaturated reactive diluents having at least two free radically polymerizable C═C double bonds are especially the diesters and polyesters of α,β-ethylenically unsaturated mono- and/or dicarboxylic acids, such as acrylic and methacrylic acid, with diols or polyols. Esters of alkoxylated polyols with α,β-ethylenically unsaturated mono- and/or dicarboxylic acids, for example the poly(meth)acrylates of alkoxylated trimethylolpropane, glycerol or pentaerythritol, and also of diethylene glycol, triethylene glycol, dipropylene glycol or tripropylene glycol may also be used. Additionally esters of alicyclic diols, such as cyclohexanediol di(meth)acrylate and bis(hydroxymethyl ethyl)cyclohexanedi(meth)acrylate may be used.

Preferably, the unsaturated reactive diluent is chosen among ethoxylated trimethylolpropane triacrylate, trimethylolpropane triacrylate, hexanediol diacrylate, hexanediol dimethacrylate, pentaerythrityl tetraacrylate, dipentaerythrityl hexaacrylate, tripropylene glycol diacrylate, or lauryl acrylate.

The polyurethane of the invention has a measured weight average molecular weight (Mw) preferably in the range from 1,000 to 12,000 g/mol, more preferably in the range from 4,000 to 8,000 g/mol. The molecular weight may be measured by Gel Permeation Chromatography (GPC) using tetrahydrofuran as solvent and polystyrene standards.

The aqueous radiation-curable coating composition of the invention contains from 10 to 600 meq/100 g (dry matter) of radiation curable unsaturated groups; in a preferred embodiment the aqueous radiation-curable coating composition contains from 50 to 200 meq/100 g (dry matter) of radiation curable unsaturated groups.

The amount of radiation curable carbon-carbon double bonds, expressed in meq/100 g, may be determined from the iodine number as determined by the Standard Test Method ASTM D1541-97 by potentiometric titration.

The aqueous radiation curable coating composition of the invention may further comprise conventional additives, such as surfactants, pigments or colorants, levelling agents, wetting agents, slip agents, defoamers, matting agents, coalescing agents or rheology modifiers.

The method here described is suitable for coating various substrates including glass, metal, wood, paper, wood decoration paper, dry wall, and synthetic materials (such as plastics including elastomeric substrates), PVC flooring, ceramic, concrete, plaster board, gypsum-board, mortar, brick, and the like.

The aqueous radiation curable coating compositions are applied to the substrate to be coated in the desired thickness.

The coating is generally applied in a range from about 0.1 to 250 g/m² and preferably from 0.5 to 80 g/m² (dry matter). The coating composition is applied to the substrate in a coating thickness (before curing) of from 3 to 200 micron, more preferably from 3 to 150 micron.

In step i) of the method for coating of the present invention, the application of the aqueous radiation curable coating composition to the substrate can be effected in any known manner, for example by spreading (e.g., with paint pad, or by brushing or rolling or knife coating), spraying (e.g., air-fed spray, airless spray, hot spray, and electrostatic spray), troweling, flow coating (e.g., pouring, dipping, curtain coating, roller coating, and reverse roller coating), and electrodeposition.

In step ii) of the method for coating of the present invention, the volatile constituents from the compositions are thermally removed, i.e. by heating or simple prolonged evaporation at room temperature.

Optionally, between step ii) and step iii), the uncured coating layer obtained in step ii) may be irradiated with UV light having a wavelength of from 300 to 450 nm, preferably from 300 to 420 nm with a radiation dose which results in partial curing of the layer, preferably with a radiation dose from 20 to 200 mJ/cm², more preferably with a radiation dose from 30 to 100 mJ/cm². In this optional step, also known as pre-curing, the coating layer partially cures but is not yet fully cured. Pre-curing takes preferably under atmospheric conditions.

In step iii) of the method for coating of the present invention, the coating layer obtained in step ii) is irradiated with UV light having a wavelength λ≤300 nm under inert gas, preferably with a wavelength λ≥120 nm is applied, causing micro-folding.

Suitable radiation sources for step iii) are excimer UV lamps, which emit UV light with a wavelength λ≤300 nm, preferably ≤220 nm, and with a wavelength λ≥120 nm, more preferably ≥150 nm, particularly preferably 172 nm or 195 nm. The radiation dose used in step iii) is usually in the range from 0.1 to 150 mJ/cm², preferably in the range of from 1 to 100 mJ/cm², more preferably from 1 to 20 mJ/cm², more preferably from 2 to 15 mJ/cm².

Step iii) must be performed in an inert gas atmosphere. An inert gas atmosphere is understood to mean an essentially oxygen-free atmosphere, i.e. an atmosphere which contains less than 0.5 percent by volume of oxygen, preferably less than 0.1 percent by volume of oxygen and especially preferably less than 0.05 percent by volume of oxygen. As a rule, an inert gas atmosphere is achieved by flushing the area which is exposed to the UV radiation with a stream of inert gas. The inert gas atmosphere prevents undesired ozone formation on the one hand and prevents the polymerization of the lacquer layer from being inhibited on the other hand. Examples of inert gases are nitrogen, carbon dioxide, combustion gases, helium, neon or argon. Nitrogen is particularly preferably used. This nitrogen should only contain very small amounts of foreign gases such as oxygen, preferably with a purity grade of <500 ppm oxygen.

In step iv) of the method for coating of the present invention, the coating layer obtained in step iii) is irradiated with UV light having a wavelength λ≥250 nm, preferably ≥300 nm, or with E-beam to achieve that the radiation-curable compounds of the coating composition largely or completely polymerize. Step iv) can optionally take place in the presence of an inert atmosphere.

In case E-beam irradiation is applied in step iv), electrons have an energy between about 50 and about 300 kV electrons, preferably between 80 and 180 kV electrons. The dosage of high energy electron ranges from about 2 to about 20 megarads (Mrads), preferably from 5 to 15 Mrads.

In case UV irradiation is applied in step iv), a wavelength λ of from 300 to 420 nm is preferred, with a radiation dose of from 100 to 5000 mJ/cm², preferably from 150 to 2500 mJ/cm².

According to the invention, high- and medium-pressure mercury vapour lamps can be used as UV radiation sources, wherein the mercury vapour can be doped with further elements such as gallium or iron. UV-A-emitting radiation sources such as LED lamps are also suitable. In case UV irradiation is applied in step iv), the aqueous radiation-curable coating composition comprises a photoinitiator. If the aqueous radiation-curable coating composition of the invention comprise one or more photoinitiators, they are included in an amount sufficient to obtain the desired cure response. Typically, the one or more photoinitiators are included in amounts ranging from 0.1 to 10% by weight of the coating composition. A photoinitiator is a compound that chemically changes due to the action of light or the synergy between the action of light and the electronic excitation of a sensitizing dye to produce at least one of a radical, an acid, and a base. Suitable photoinitiators are free-radical photoinitiators of type I) or type II), alone or in combination with an amine synergist. In the context of the present invention, it has been found that the aqueous radiation-curable coating compositions are particularly useful for providing low gloss coating with improved chemical resistances, if, after drying, they allow to obtain a “tacky” film. A film is considered “tacky” when it retains on its surface absorbent cotton fibres that have been dropped on its surface, after blowing lightly, according to the standard test method ASTM D1640/D1640M-14 (2018).

The content of the present invention is further illustrated by the following examples.

### EXAMPLES

### Synthesis Examples

### Example 1

Example 1 concerns the preparation of a polyurethane, wherein the molar ratio between the amino groups of the capping agent and the isocyanate groups (NCO) of the prepolymer is 0.5. 61.36 g (0.061 mol) of pTHF1000 (poly(tetramethylene glycol)diol, having an average molecular weight of 1000 g/mol) and 3.79 g (0.026 mol) of 1,4-cyclohexanedimethanol and 19.67 g of dimethylol propionic acid (DMPA) (0.147 mol) are charged in a reactor vessel equipped with thermometer, stirrer and condenser, at room temperature.

70.13 g of pentaerythrityl triacrylate (PETIA) (0.138 mol) and 69.50 g of ethoxylated trimethylolpropane triacrylate (0.162 mol) are added under stirring to the mixture.

104.15 g of isophorone diisocyanate (IPDI) (0.469 mol) are added under stirring and the mixture is stirred for 10 minutes at 40° C. The reaction mixture is then heated up at 85° C. and the reaction is carried out at 85° C. until the residual content of NCO group in the prepolymer is 4.23%. The titration of the residual isocyanate group has been determined according to the standard method ASTM D2572.

Once reached the required value of NCO groups, the prepolymer is cooled down at 80° C. and 21.39 g (0.166 mol) of dibutylamine are added dropwise under stirring.

Then, the prepolymer is cooled down at 70° C. and 13.64 g (0.135 mol) of triethylamine (TEA) are added under stirring.

300 g of the neutralised prepolymer are dispersed in 525 g of demineralised water under vigorous stirring. An aqueous dispersion having a solids content of 35 wt % is obtained.

### Example 2

Example 2 concerns the preparation of a polyurethane, wherein the molar ratio between the amino groups of the capping agent and the isocyanate groups (NCO) of the prepolymer is 0.5.

78.29 g (0.078 mol) of polycarbonate diol derived from 1,6-hexanediol (molecular weight 1000 g/mol) and 18.92 g of dimethylol propionic acid (DMPA) (0.141 mol) are charged in a reactor vessel equipped with thermometer, stirrer and condenser, at room temperature. 65.62 g of pentaerythrityl triacrylate (PETIA) (0.129 mol) and 69.50 g of hexanediol diacrylate (0.162 mol) are added under stirring to the mixture.

97.46 g of isophorone diisocyanate (IPDI) (0.438 mol) are added under stirring and the mixture is stirred for 10 minutes at 40° C. The reaction mixture is then heated up at 85° C. and the reaction is carried out at 85° C. until the residual content of NCO group in the prepolymer is 3.95%. The titration of the residual isocyanate group has been determined according to the standard method ASTM D2572.

Once reached the required value of NCO groups, the prepolymer is cooled down at 80° C. and 20.02 g (0,155 mol) of dibutylamine are added dropwise under stirring.

Then, the prepolymer is cooled down at 70° C. and 13.11 g (0.130 mol) of triethylamine (TEA) are added under stirring.

300 g of the neutralised prepolymer are dispersed in 526 g of demineralised water under vigorous stirring.

An aqueous dispersion having a solids content of 28.51 wt % is obtained.

### Example 3

Example 3 concerns the preparation of a polyurethane, wherein the molar ratio between the amino groups of the capping agent and the isocyanate groups (NCO) of the prepolymer is 1.0. 70.06 g (0.070 mol) of polycarbonate diol derived from 1,6-hexanediol (molecular weight 1000 g/mol) and 18.81 g of dimethylol propionic acid (DMPA) (0.140 mol) are charged in a reactor vessel equipped with thermometer, stirrer and condenser, at room temperature.

58.73 g of pentaerythrityl triacrylate (PETIA) (0.115 mol) and 69.50 g of hexanediol diacrylate (0.162 mol) are added under stirring to the mixture.

93.45 g of isophorone diisocyanate (IPDI) (0,420 mol) are added under stirring and the mixture is stirred for 10 minutes at 40° C. The reaction mixture is then heated up at 85° C. and the reaction is carried out at 85° C. until the residual content of NCO group in the prepolymer is 4.13%. The titration of the residual isocyanate group has been determined according to the standard method ASTM D2572.

Once reached the required value of NCO groups, the prepolymer is cooled down at 80° C. and 39.45 g (0.305 mol) of dibutylamine are added dropwise under stirring.

Then, the prepolymer is cooled down at 70° C. and 13.04 g (0.129 mol) of triethylamine (TEA) are added under stirring.

300 g of the neutralised prepolymer are dispersed in 526 g of demineralised water under vigorous stirring.

An aqueous dispersion having a solids content of 28.34 wt % is obtained.

### Example 4

Example 4 concerns the preparation of a polyurethane, wherein the molar ratio between the amino groups of the capping agent and the isocyanate groups (NCO) of the prepolymer is 0.5. 77.73 g (0.078 mol) of polycarbonate diol derived from 1,6-hexanediol (molecular weight 1000 g/mol) and 18.78 g of dimethylol propionic acid (DMPA) (0.140 mol) are charged in a reactor vessel equipped with thermometer, stirrer and condenser, at room temperature.

65.15 g of pentaerythrityl triacrylate (PETIA) (0.128 mol) and 69.50 g of hexanediol diacrylate (0.162 mol) are added under stirring to the mixture.

96.76 g of isophorone diisocyanate (IPDI) (0,435 mol) are added under stirring and the mixture is stirred for 10 minutes at 40° C. The reaction mixture is then heated up at 85° C. and the reaction is carried out at 85° C. until the residual content of NCO group in the prepolymer is 3.94%. The titration of the residual isocyanate group has been determined according to the standard method ASTM D2572.

Once reached the required value of NCO groups, the prepolymer is cooled down at 80° C. and 19.87 g (0.154 mol) of dibutylamine are added dropwise under stirring.

Then, the prepolymer is cooled down at 70° C. and 13.02 g (0.129 mol) of triethylamine (TEA) are added under stirring.

300 g of the neutralised prepolymer are dispersed in 528 g of demineralised water under vigorous stirring. The residual NCO is extended with hydrazine hydrate 3.61 g (0.113 mol).

An aqueous dispersion having a solids content of 35 wt % is obtained.

### Example 5

Example 5 concerns the preparation of a polyurethane, wherein the molar ratio between the amino groups of the capping agent and the isocyanate groups (NCO) of the prepolymer is 1.0. 72.01 g (0.072 mol) of polycarbonate diol derived from 1,6-hexanediol (molecular weight 1000 g/mol) and 14.13 g of dimethylol propionic acid (DMPA) (0.105 mol) are charged in a reactor vessel equipped with thermometer, stirrer and condenser, at room temperature. 139 g of hexanediol diacrylate (0.614 mol) are added under stirring to the mixture.

78.83 g of isophorone diisocyanate (IPDI) (0,355 mol) are added under stirring and the mixture is stirred for 10 minutes at 40° C. The reaction mixture is then heated up at 85° C. and the reaction is carried out at 85° C. until the residual content of NCO group in the prepolymer is 4.90%. The titration of the residual isocyanate group has been determined according to the standard method ASTM D2572.

Once reached the required value of NCO groups, the prepolymer is cooled down at 80° C. and 45.83 g (0.355 mol) of dibutylamine are added dropwise under stirring.

Then, the prepolymer is cooled down at 70° C. and 9.80 g (0.097 mol) of triethylamine (TEA) are added under stirring.

300 g of the neutralised prepolymer are dispersed in 534 g of demineralised water under vigorous stirring.

An aqueous dispersion having a solids content of 35 wt % is obtained.

### Comparative Example A

Comparative Example A concerns the preparation of a polyurethane, wherein the molar ratio between the amino groups of the capping agent and the isocyanate groups (NCO) of the prepolymer is 0.5, but the reaction between the prepolymer and the capping agent took place after that the prepolymer was dispersed in water.

69.92 g (0.07 mol) of pTHF1000 (poly(tetramethylene glycol)diol, having an average molecular weight of 1000 g/mol) and 4.32 g (0.03 mol) of 1,4-cyclohexanedimethanol and 18.57 g of dimethylol propionic acid (DMPA) (0.138 mol) are charged in a reactor vessel equipped with thermometer, stirrer and condenser, at room temperature.

68.04 g of pentaerythrityl triacrylate (PETIA) (0.133 mol) and 60.83 g of ethoxylated trimethylolpropane triacrylate (0.142 mol) are added under stirring to the mixture.

105.92 g of isophorone diisocyanate (IPDI) (0.476 mol) are added under stirring and the mixture is stirred for 10 minutes at 40° C. The reaction mixture is then heated up at 85° C. and the reaction is carried out at 85° C. until the residual content of NCO group in the prepolymer is 4.40%. The titration of the residual isocyanate group has been determined according to the standard method ASTM D2572.

Once reached the required value of NCO groups, the prepolymer is cooled down at 70° C. and 12.87 g (0.127 mol) of triethylamine (TEA) are added under stirring.

300 g of the neutralised prepolymer are dispersed in 558 g of demineralised water under vigorous stirring. The residual NCO is partially end capped with diethanolamine 15.72 g (0.151 mol), then the remaining portion is extended with hydrazine hydrate 7.88 g (0.246 mol).

An aqueous dispersion having a solids content of 35 wt % is obtained.

### Comparative Example B

Comparative Example B concerns the preparation of a polyurethane, wherein the molar ratio between the amino groups of the capping agent and the isocyanate groups (NCO) of the prepolymer is 0.25.

79.40 g (0.079 mol) of a polycarbonate diol derived from 1,6-hexanediol (molecular weight 1000 g/mol) and 19.18 g of dimethylol propionic acid (DMPA) (0.143 mol) are charged in a reactor vessel equipped with thermometer, stirrer and condenser, at room temperature.

66.55 g of pentaerythrityl triacrylate (PETIA) (0.130 mol) and 69.50 g of hexanediol diacrylate (0.162 mol) are added under stirring to the mixture.

98.84 g of isophorone diisocyanate (IPDI) (0.445 mol) are added under stirring and the mixture is stirred for 10 minutes at 40° C. The reaction mixture is then heated up at 85° C. and the reaction is carried out at 85° C. until the residual content of NCO group in the prepolymer is 3.96%. The titration of the residual isocyanate group has been according to the standard method ASTM D2572.

Once reached the required value of NCO groups, the prepolymer is cooled down at 80° C. and 10.15 g (0.079 mol) of dibutylamine are added dropwise under stirring.

Then, the prepolymer is cooled down at 70° C. and 13.30 g (0.131 mol) of triethylamine (TEA) are added under stirring.

300 g of the neutralised prepolymer are dispersed in 558 g of demineralised water under vigorous stirring. Then the remaining portion is extended with hydrazine hydrate 5.61 g (0.175 mol).

An aqueous dispersion having a solids content of 35 wt % is obtained.

### Comparative Example C

Comparative Example C concerns the preparation of a polyurethane, wherein the prepolymer is not reacted with a capping agent.

128.93 g (0.129 mol) of polycarbonate diol derived from 1,6-hexanediol (molecular weight 1000 g/mol) and 17.30 g of dimethylol propionic acid (DMPA) (0.129 mol) are charged in a reactor vessel equipped with thermometer, stirrer and condenser, at room temperature.

28.93 g of pentaerythrityl triacrylate (PETIA) (0.057 mol) and 55.19 g of ethoxylated trimethylolpropane triacrylate (0.185 mol) are added under stirring to the mixture.

85.98 g of isophorone diisocyanate (IPDI) (0.387 mol) are added under stirring and the mixture is stirred for 10 minutes at 40° C. The reaction mixture is then heated up at 85° C. and the reaction is carried out at 85° C. until the residual content of NCO group in the prepolymer is 2.67%. The titration of the residual isocyanate group has been determined according to the standard method ASTM D2572.

Once reached the required value of NCO groups, methyl ethyl ketone is added to the mix (80.12 g).

Then the prepolymer is cooled down at 70° C. and 12.00 g (0.119 mol) of triethylamine (TEA) are added under stirring. 300 g of the neutralised prepolymer are dispersed in 430 g of demineralised water under vigorous stirring. The residual NCO is extended with ethylenediamine 4.17 g (0.069 mol). An aqueous dispersion having a solids content of 39.35 wt % is obtained.

### Comparative Example D

Comparative Example D concerns the preparation of a polyurethane, wherein the prepolymer is not reacted with a capping agent.

82.89 g (0.083 mol) of polycarbonate diol derived from 1,6-hexanediol (molecular weight 1000 g/mol) and 20.02 g of dimethylol propionic acid (DMPA) (0.149 mol) are charged in a reactor vessel equipped with thermometer, stirrer and condenser, at room temperature.

69.48 g of pentaerythrityl triacrylate (PETIA) (0.136 mol) and 69.50 g of hexanediol diacrylate (0.162 mol) are added under stirring to the mixture.

103.19 g of isophorone diisocyanate (IPDI) (0,464 mol) are added under stirring and the mixture is stirred for 10 minutes at 40° C. The reaction mixture is then heated up at 85° C. and the reaction is carried out at 85° C. until the residual content of NCO group in the prepolymer is 3.99%. The titration of the residual isocyanate group has been determined according to the standard method ASTM D2572.

Then, the prepolymer is cooled down at 70° C. and 13.88 g (0.137 mol) of triethylamine (TEA) are added under stirring.

300 g of the neutralised prepolymer are dispersed in 509 g of demineralised water under vigorous stirring. The residual NCO is extended with hydrazine hydrate 7.74 g (0.242 mol).

An aqueous dispersion having a solids content of 35 wt % is obtained.

### Applicative Tests

### Preparation of the Formulations

Formulations (Examples 6-14) were prepared using the ingredients listed and the amount reported (as % by weight) in Table 1.

### Application of the Formulations

The formulations were applied to substrates manually, by using a wire rod bar, in order to have 30 g/m² dry film thickness. The substrates used were white melamine panels sanded with a 320 grit sandpaper.

### Drying

The treated substrates were subsequently dried using Lamitech® AC 10, a laminar drying tunnel (commercially available from Giardina Group Finishing Solutions) with a 0.6 m/s air flow, for 15 minutes at 50° C.

### Curing of the Formulations

The dried substrates were then irradiated using ExcimerTech® Zerogloss 710 (commercially available from Giardina Group Finishing Solutions), an apparatus consisting of two lamps, at a linespeed of 5 m/min. The first lamp was an excimer lamp operating at a wavelength λ of 172 nm, at distance of 40 mm from the substrate, and in a nitrogen atmosphere (O₂ level<500 ppm). The second lamp was a Hg lamp, operating at a wavelength λ≥250 nm and at 120 W/m.

### Tackiness

The tackiness of the film obtained after drying was measured according to standard method ASTM D1640/D1640M-14 (2018). “Yes” means that a “tacky” film is obtained. “No” means that a “tack-free” film is obtained.

### Gloss Measurements

The gloss has been determined by means of application of the aqueous radiation curable coating compositions on a white melamine laminate and measured at 60° or 85°, following the ISO standard method 2813-2014.

The 60° gloss of the aqueous coating composition after drying is ≤15, preferably ≤2. The 85° gloss of the aqueous coating composition after drying is ≤60, preferably ≤25.

### Staining Resistance

The resistance to various liquids such as coffee, mustard, Betadine® disinfectant (iodine resistance) was tested according to the standard method UNI EN 12720:2013. The test duration was 1 hour or 16 hours. For each sample a score from 1 (=film completely damaged) to 5 (=no visible damage) is assigned.

TABLE 1

| | Applicative Example | | | | | | | | |
|---|---|---|---|---|---|---|---|---|---|
| | 6* | 7* | 8* | 9 | 10 | 11 | 12 | 13* | 14 |
| Comparative Example C | 76.2 | | | | | | | | |
| Comparative Example A | | 85.7 | | | | | | | |
| Comparative Example B | | | 85.7 | | | | | | |
| Comparative Example D | | | | | | | | 85.7 | |
| Example 1 | | | | 85.7 | | | | | |
| Example 2 | | | | | 87.7 | | | | |
| Example 3 | | | | | | 88.2 | | | |
| Example 4 | | | | | | | 85.7 | | |
| Example 5 | | | | | | | | | 81.1 |
| Photoinitiator¹ | 1.2 | 1.2 | 1.2 | 1.2 | 1.0 | 1.0 | 1.2 | 1.2 | 1.2 |
| BYK ® 349² | 0.3 | 0.3 | 0.3 | 0.3 | 0.3 | 0.3 | 0.3 | 0.3 | 0.3 |
| Water | 21.0 | 11.5 | 11.5 | 11.5 | 9.8 | 9.2 | 11.5 | 11.4 | 11.8 |
| Viscolam PS 170 Air³ | 1.3 | 1.3 | 1.3 | 1.3 | 1.3 | 1.3 | 1.3 | 1.3 | 1.3 |

*Comparative
¹Omnirad ® TPO, commercially available from IGM Resins, diluted 1:1 with butyl diglycol
²Silicone surfactant, commercially available from BYK-Chemie Gmbh
³HEUR thickener, commercially available from Lamberti Spa, diluted 1:4 with water The aqueous radiation-curable coating compositions of Examples 6, 7, 8, 9, 12, 13 and 14 have a solids content of 30 wt % and were applied to form a coating having a thickness of 100 μm.

The aqueous radiation-curable coating compositions of Examples 10 and 11 have a solids content of 25 wt % and were applied to form a coating having a thickness of 120 μm.

The results of the applicative tests are reported in Table 2.

TABLE 2

| | Applicative Example | | | | | | | | |
|---|---|---|---|---|---|---|---|---|---|
| | 6* | 7* | 8* | 9 | 10 | 11 | 12 | 13* | 14 |
| Gloss 60° | 84.3 | 90.9 | 91.1 | 13.9 | 13.6 | 13.4 | 12.4 | 92.0 | 4.3 |
| Gloss 85° | 95.6 | 93.8 | 94.8 | 24.9 | 22.5 | 20.2 | 16.5 | 94.2 | 1.0 |
| Tackiness | No | No | No | Yes | Yes | Yes | Yes | No | Yes |
| Coffee resistance (1 hour) | 4 | 2 | 5 | 5 | 5 | 5 | 5 | 5 | 5 |
| Mustard resistance (1 hour) | 3 | 3 | 5 | 5 | 5 | 5 | 5 | 5 | 5 |
| Mustard resistance (16 hours) | 2 | 2 | 4 | 4 | 4/5 | 4 | 5 | 5 | 5 |
| Iodine resistance (1 hour) | 4 | 2 | 4 | 4 | 5 | 4 | 4/5 | 5 | 5 |

*Comparative

The results reported in Table 2 show that only the aqueous radiation-curable coating compositions of the present invention allow to obtain at the same time low gloss coatings and improved stain resistances.

1.-10. (canceled)

11. A method for coating a substrate comprising:
i) applying an aqueous radiation-curable coating composition to said substrate;
ii) thermally drying the applied aqueous radiation-curable coating composition;
iii) irradiating the thermally dried composition with UV light having a wavelength≤300 nm under inert gas;
iv) irradiating the thermally dried composition with UV light having a wavelength≥250 nm or with E-beam,
wherein the aqueous radiation-curable coating composition comprises:
A) from 15 to 60 wt % (% by weight) of a polyurethane, wherein said polyurethane is obtained by a process comprising the following steps:
I) a prepolymer is obtained by reacting:
a) from 20 to 60 wt % of at least one aliphatic or cycloaliphatic diisocyanate;
b) from 0.5 to 10 wt % of least one diol having at least one carboxylic or carboxylate group;
c) from 10 to 60 wt % of at least one diol with molecular weight between 500 and 5,000 g/mol;
d) from 0 to 40 wt % of at least one ethylenically unsaturated compound containing one reactive group capable to react with an isocyanate;
e) from 0 to 10 wt % of at least one diol or at least one polyol different from diols b) and c);
f) from 0 to 20 wt % of an aliphatic or cycloaliphatic polyisocyanate having average functionality above 2,
wherein the percentage amounts of a), b), c), d), e) and f) are referred to the sum of a)+b)+c)+d)+e)+f);
II) the prepolymer obtained in step I) is reacted with a capping agent, said capping agent being a secondary amine or a monoalcohol, in such proportions that the molar ratio between the amino groups or hydroxy groups of the capping agent and the isocyanate groups (NCO) of the prepolymer is between 0.3 and 1;
III) the capped prepolymer obtained in step II) is dispersed in water;
B) from 1 to 35 wt % of at least one unsaturated reactive diluent.

12. The method for coating a substrate according to claim 11, wherein the capping agent is a secondary amine.

13. The method for coating a substrate according to claim 11, wherein the capping agent is a secondary amine selected among dimethylamine, diethylamine, dipropylamine, diisopropylamine, dibutylamine, N-propyl butylamine, N-methyl ethanolamine or diethanolamine.

14. The method for coating a substrate according to claim 11, wherein the capping agent is dibutylamine.

15. The method for coating a substrate according to claim 11, wherein the prepolymer obtained in step I) is reacted with a capping agent, said capping agent being a secondary amine or a monoalcohol, in such proportions that the molar ratio between the amino groups or hydroxy groups of the capping agent and the isocyanate groups (NCO) of the prepolymer is between 0.5 and 1.

16. The method for coating a substrate according to claim 15, wherein the capping agent is a secondary amine.

17. The method for coating a substrate according to claim 11, wherein the reactive diluent is selected among ethoxylated trimethylolpropane triacrylate, trimethylolpropane triacrylate, hexanediol diacrylate, hexanediol dimethacrylate, pentaerythrityl tetraacrylate, dipentaerythrityl hexaacrylate, tripropylene glycol diacrylate, or lauryl acrylate.

18. The method for coating a substrate according to claim 11, wherein the polyurethane has a weight average molecular weight (Mw) in the range from 1,000 to 12,000 g/mol.

19. The method for coating a substrate according to claim 11, wherein the aqueous radiation-curable coating composition contains from 10 to 600 meq/100 g (dry matter) of radiation curable unsaturated groups.

20. The method for coating a substrate according to claim 11, wherein the aqueous radiation-curable coating composition further comprises surfactants, pigments or colorants, levelling agents, wetting agents, slip agents, defoamers, matting agents, coalescing agents or rheology modifiers.

21. The method for coating a substrate according to claim 11, wherein in step iii) the thermally dried composition is irradiated with UV light having a wavelength≤220 nm under inert gas.

22. The method for coating a substrate according to claim 11, wherein in step iv) the thermally dried composition is irradiated with UV light having a wavelength≥300 nm or with E-beam
